(19) United States
(12) Patent Application Publication
(10) Pub. No.: US 2016/0024834 A1
(43) Pub. Date: Jan. 28, 2016

(54) SLIDE DOOR OF MACHINE TOOL

(71) Applicant: FANUC Corporation, Yamanashi (JP)

(72) Inventor: Akihiko NAGAO, Yamanashi (JP)

(21) Appl. No.: 14/807,987

(22) Filed: Jul. 24, 2015

(30) Foreign Application Priority Data
Jul. 25, 2014 (JP) 2014-151703

(51) Int. Cl. E05F 15/652; E06B 3/46

(52) U.S. Cl. CPC E05F 15/652; E06B 3/46; E05Y 2900/608

(57) ABSTRACT

A slide door of a machine tool which slide door is constituted by first and second doors for opening and closing, in a sliding manner, an opening of the machine tool includes: a first nut fixed to the first door; a first ball screw engaged threadedly to the first nut; a second ball screw placed in parallel with the first ball screw; a second nut engaged threadedly to the second ball screw and fixed to the second door is fixed thereto; and a motor for driving the first and second ball screws via a power transmission mechanism.

### BACKGROUND OF THE INVENTION

1. Field of the Invention

The present invention relates to a door provided in a cover for covering a machining space in which a workpiece is cut in a machine tool.

2. Description of the Related Art

In a machine tool, chips caused in cutting and a coolant discharged to a machining region are scattered all over. In order to prevent the scattering outside the machine tool, a machining space is covered with a cover. In the meantime, it is necessary to access the machining space so as to take a workpiece in and out of the machining space, an opening may be provided in the cover and a slide door may be provided so as to close the opening.

In a case of a large-sized workpiece, it is necessary to widen an opening width by the door. In view of this, a two-stage slide door is advantageous. Japanese Patent Application Publication No. 2006-205337 describes an example in which a two-stage slide door is provided in a machine tool. An upper end of a left door is provided with first and second pulleys attached at an interval therebetween. A wire is provided in a tensioned condition between the pulleys. Both ends of the wire are fixed to a housing wall portion, and an upper end of a right door is connected and fixed to the wire. When the right door is moved by a handle provided in the right door, the left door is also moved following the right door via the wire and the first and second pulleys, so as to open or close an opening.

In order to widen the opening width of the door, the two-stage slide door is effective. Further, in order to increase production efficiency of the machine tool, it is preferable to open and close the door at a fast speed. Further, since the machining space is in a state where chips and cutting fluid are scattered, it is desirable that the door be opened and closed by smoothly moving the door without its sliding being disturbed by the chips and the cutting fluid. Accordingly, it is necessary that a power transmission mechanism for opening and closing the door be attached to a place that is hard to be affected by the chips and the cutting fluid. In the meantime, a mounting space for the power transmission mechanism is limited around the door because a control device of the machine tool and the door may be provided in a double manner.

In addition, the door may be opened and closed by use of a motor for the purpose of speedup and automation. In this case, because of the speedup, it is desirable that the power transmission device cause less abrasion and damage.

The two-stage slide door described in Japanese Patent Application Publication No. 2006-205337 is opened and closed manually, and is configured such that one of the doors is attached to the wire, and the other one of the doors is moved via the wire and the pulleys. This causes such a problem that a large load is applied to the wire and the pulleys, which may highly possibly cause abrasion and failure of the pulleys and the wire.

### SUMMARY OF THE INVENTION

In view of this, an object of the present invention is to provide that door of a machine tool which is provided for a machining space of the machine tool so as to have a wide opening width, which achieves a high opening and closing speed, which enables automation, and which causes less abrasion and damage in a door driving mechanism.

A slide door of a machine tool, according to the present invention, is a slide door of a machine tool, which slide door is constituted by first and second doors for opening and closing, in a sliding manner, an opening provided in a fixed cover for covering a machining space of the machine tool, and the slide door includes: a first nut fixed to the first door; a first ball screw engaged threadedly to the first nut; a second ball screw placed in parallel with the first ball screw; a second nut engaged threadedly to the second ball screw and fixed to the second door; and a motor for driving the first and second ball screws via a power transmission mechanism.

Either one of the first and second ball screws may be connected to a motor shaft of the motor, instead of the power transmission mechanism, with their shaft centers being aligned, and the one of the ball screws may be connected to the other one of the ball screws via the power transmission mechanism.

Two motors may be provided instead of the power transmission mechanism, and the first ball screw may be driven by one of the motors, and the second ball screw may be driven by the other one of the motors.

The power transmission mechanism may include a speed change mechanism for rotating the first ball screw and the second ball screw at a predetermined rotational speed ratio.

The first ball screw and the second ball screw may have different leads, and the first and second doors may have different moving speeds and different strokes.

The first door and the second door may be moved in the same direction, the second door may be moved by a stroke longer than a stroke of the first door, and at the time when the opening is opened fully, the first door and the second door may be placed at an accommodation position so as to overlap with each other.

The first door and the second door may be moved in opposite directions so as to open and close the opening.

Instead of placing the power transmission mechanism and the first and second ball screws in parallel with each other, a motor shaft of the motor, the first ball screw, and the second ball screw may be connected in series so as to be fixed to each other with their shaft centers being aligned, and the first ball screw and the second ball screw may have different leads.

Instead of placing the power transmission mechanism and the first and second ball screws in parallel with each other, a motor shaft of the motor, the first ball screw, and the second ball screw may be connected in series so as to be fixed to each other with their shaft centers being aligned, and threading directions of the first ball screw and the second ball screw may be opposite to each other.

The present invention has the above configuration. Since the opening is opened and closed by two doors that slide, an opening width becomes wide. Besides, the doors are driven by the motor via the ball screws, thereby achieving fast opening and closing of the doors and enabling automation. In addition, since the doors are opened and closed via the ball screws, abrasion and damage are hardly caused, thereby making it possible to stably open and close the doors fast. Further, since respective ball screws are disposed in parallel so as to open and close two slide doors and a slide direction of the doors is the same as an axial direction of the ball screws, a mounting space can be made compact with less wasteful space.

### BRIEF DESCRIPTION OF THE DRAWINGS

The above and other objects and features of the present invention will be obvious from the ensuing description of embodiments with reference to the accompanying drawings, in which:

FIGS. 1A, 1B, 1C, 1D are schematic diagrams each illustrating a first embodiment of the present invention;

FIGS. 2A, 2B, 2C are explanatory views of a power transmission mechanism;

FIGS. 3A, 3B, 3C, 3D, 3E, 3F are explanatory views each illustrating an example of a placement position of ball screws and doors;

FIG. 4 is a schematic diagram illustrating a second embodiment of the present invention;

FIGS. 5A, 5B are schematic diagrams each illustrating a first aspect of a third embodiment of the present invention; and

FIGS. 6A, 6B are schematic diagrams each illustrating a second aspect of the third embodiment of the present invention.

### DETAILED DESCRIPTION OF THE PREFERRED EMBODIMENTS

In the following embodiment, two ball screws are placed in parallel or in series, and doors fixed to respective nuts engaged threadedly to the ball screws are slid so as to open and close an opening. Hereby, it is possible to obtain the opening which is compact and which has a wide opening width by two doors.

### First Embodiment

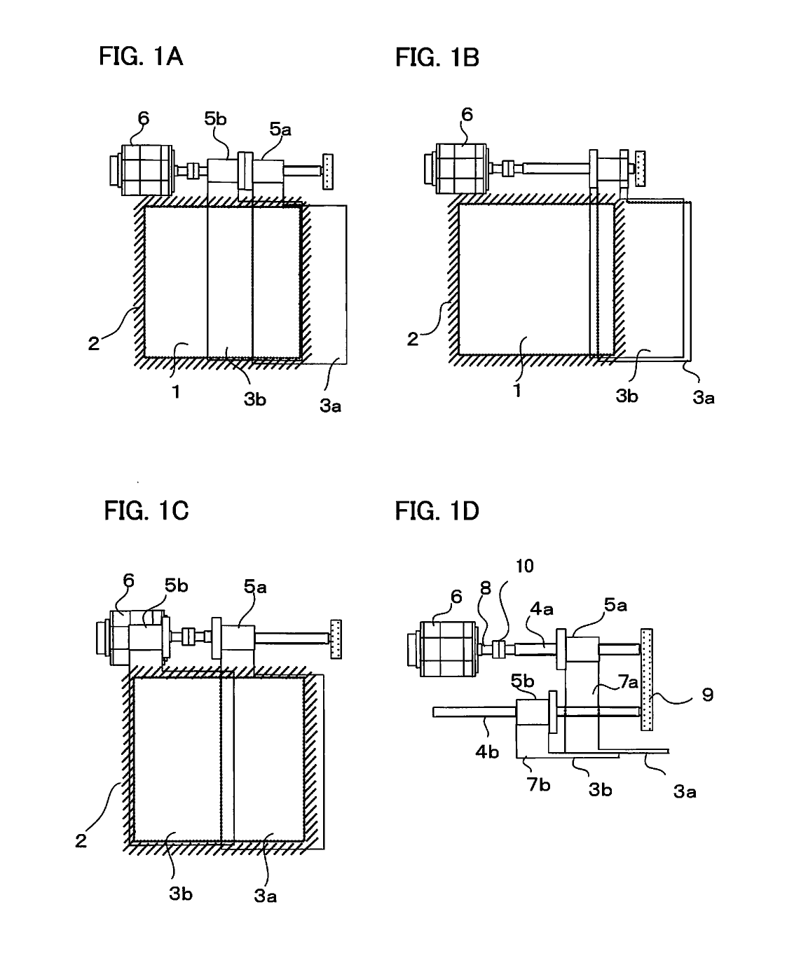

FIGS. 1A, 1B, 1C, 1D are schematic diagrams each illustrating a first embodiment of the present invention. FIGS. 1A, 1B, 1C are front views: FIG. 1A illustrates a state where an opening is opened halfway; FIG. 1B illustrates a state where the opening is opened fully; and FIG. 1C illustrates a state where the opening is closed. Further, FIG. 1D is a plane view.

A machining space in which a workpiece is cut with a cutter is covered with a fixed cover 2, and first and second doors 3a, 3b for opening and closing an opening 1 provided in the fixed cover 2 is provided. Two ball screws, i.e., first and second ball screws 4a, 4b are disposed in parallel with each other on an upper side relative to the first and second doors 3a, 3b, and a first nut 5a and a second nut 5b are engaged threadedly to the first ball screw 4a and the second ball screw 4b, respectively. An extension member 7a of the first door 3a is fixed to the first nut 5a, and an extension member 7b of the second door 3b is fixed to the second nut 5b. The first ball screw 4a is connected to a motor shaft 8 of a motor 6 via a shaft coupling 10 with their shaft centers being aligned. Further, the first ball screw 4a is connected to the second ball screw 4b via a power transmission mechanism 9.

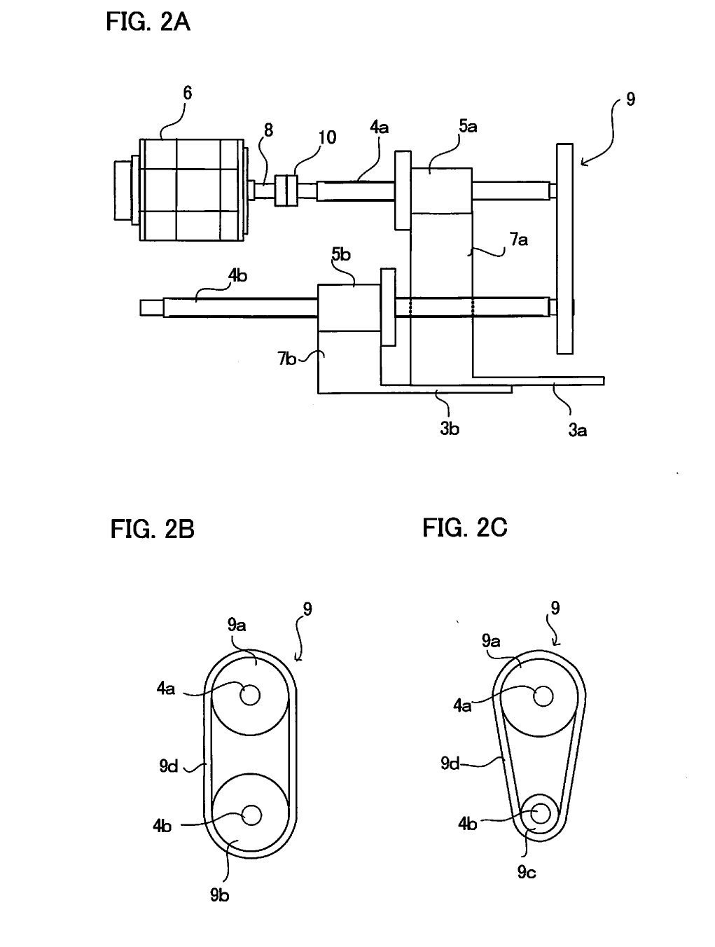

FIGS. 2A, 2B, 2C, 2D are explanatory views of the power transmission mechanism 9. FIG. 2A is the same plan view as FIG. 1D, FIG. 2B illustrates a first aspect of the power transmission mechanism 9, and FIG. 2C illustrates a second aspect of the power transmission mechanism 9. A first pulley 9a is fixed to a shaft of the first ball screw 4a, and a second pulley 9b or 9c is fixed to a shaft of the second ball screw 4b. A belt 9d is provided over between the first pulley 9a and the second pulley 9b, 9c, so that a rotation of the first ball screw 4a is transmitted to the second ball screw 4b by belt transmission.

In a case of the power transmission mechanism 9 illustrated in FIG. 2B, by use of the pulleys 9a, 9b having the same diameter for the first and second ball screws 4a, 4b, the first and second ball screws 4a, 4b are rotated at the same rotation speed. On the other hand, in a case of the power transmission mechanism 9 illustrated in FIG. 2C, the pulley 9c attached to the second ball screw 4b has a diameter smaller than that of the pulley 9a attached to the first ball screw 4a, so that the second ball screw 4b is rotated faster than the first ball screw 4a.

In the meantime, as illustrated in FIGS. 1A, 1B, 1C, a moving amount of the second door 3b, namely, a stroke thereof, is longer than a stroke of the first door 3a. Accordingly, in a case where the power transmission mechanism 9 illustrated in FIG. 2B is used, a lead of the second ball screw 4b is set longer than a lead of the first ball screw 4a. Hereby, a moving speed of the second nut 5b (the second door 3b) is made faster than a moving speed of the first nut 5a (the first door 3a), thereby adjusting stroke amounts of the first and second doors 3a, 3b.

Further, in a case where the power transmission mechanism 9 illustrated in FIG. 2C is used, the second ball screw 4b is rotated faster than the first ball screw 4a. Accordingly, it is not necessary for the first and second ball screws 4a, 4b to have different leads, that is, the first and second ball screws 4a, 4b may have the same lead. By changing a speed reducing ratio of the power transmission mechanism 9 (by changing the diameters of the pulley 9a and the pulley 9c), stroke amounts of the first and second doors 3a, 3b may be adjusted.

Note that the power transmission mechanism 9 constituted by pulleys and a belt is exemplified as a power transmission mechanism, but power transmission mechanisms respectively constituted by gears, a sprocket and a chain, a roller and a wire, a rack and a pinion, and the like may be used. Further, in the first embodiment, the motor shaft of the motor is directly connected to one of the ball screws via the shaft coupling, and the power transmission mechanism is disposed between two ball screws. However, the power transmission mechanism may be disposed between the motor shaft of the motor and each of the ball screw, so as to drive two ball screws by one motor via the power transmission mechanism. Furthermore, the following configuration may be considered that: a shaft coupling is provided instead of the power transmission mechanism so as to connect two ball screws by the shaft coupling with their shaft centers being aligned; a motor shaft of a motor is connected to the other end of one of the ball screws via a shaft coupling with their shaft centers being aligned; and ball screws having different leads are used as the two ball screws, whereby the motor is driven so as to move nuts engaged threadedly to respective ball screws, so that doors fixed to the nuts are driven at different speeds (with different stroke amounts).

Next will be described opening and closing operations of the opening by the first and second doors 3a, 3b. As illustrated in FIG. 1B, when the motor 6 is driven to a door-closing direction from a state where the first and second doors 3a, 3b are placed at an accommodation position of the fixed over 2 generally in an overlap manner so that the opening 1 is opened to the maximum, the first ball screw 4a pivots, and the second ball screw 4b also pivots via the power transmission mechanism 9. Hereby, the first and second nuts 5a, 5b and the first and second doors 3a, 3b are moved. However, due to a difference in lead between the first ball screw 4a and the second ball screw 4b, or due to the speed reducing ratio of the power transmission mechanism 9, the second nut 5b and the second door 3b are moved faster than the first nut 5a and the first door 3a (see FIG. 1A).

As illustrated in FIG. 1C, when a tip end of the second door 3b reaches the other tip end of the opening 1 so that the second door 3b partially overlaps with the fixed cover 2 and driving of the motor 6 is stopped, about half of the opening 1 is closed by the second door 3b, and the first door 3a partially overlaps with a rear end of the second door 3b so as to close a remaining part of the opening 1. Hereby, the opening 1 is closed by the two doors 3a, 3b.

As illustrated in FIG. 1C, in order to completely close the opening 1, it is necessary that the tip end of the second door 3b and a rear end of the first door 3a overlap with the fixed cover 2, and the rear end of the second door 3b and a tip end of the first door 3a overlap with each other. In view of this, widths of the first and second doors 3a, 3b (widths of the doors in a moving stroke direction) may be made slightly wider than half of the opening 1 in consideration of such overlapping portions. Hereby, as illustrated in FIG. 1B, at the time when the opening 1 is opened fully and the first and second doors 3a, 3b are placed at the accommodation position of the fixed cover 2, a width of an accommodation region for a slide cover can be set to about half of the opening 1, more specifically, slightly larger than half of the opening 1 in consideration of the overlapping portions described above. This makes it possible to form the accommodation region compactly.

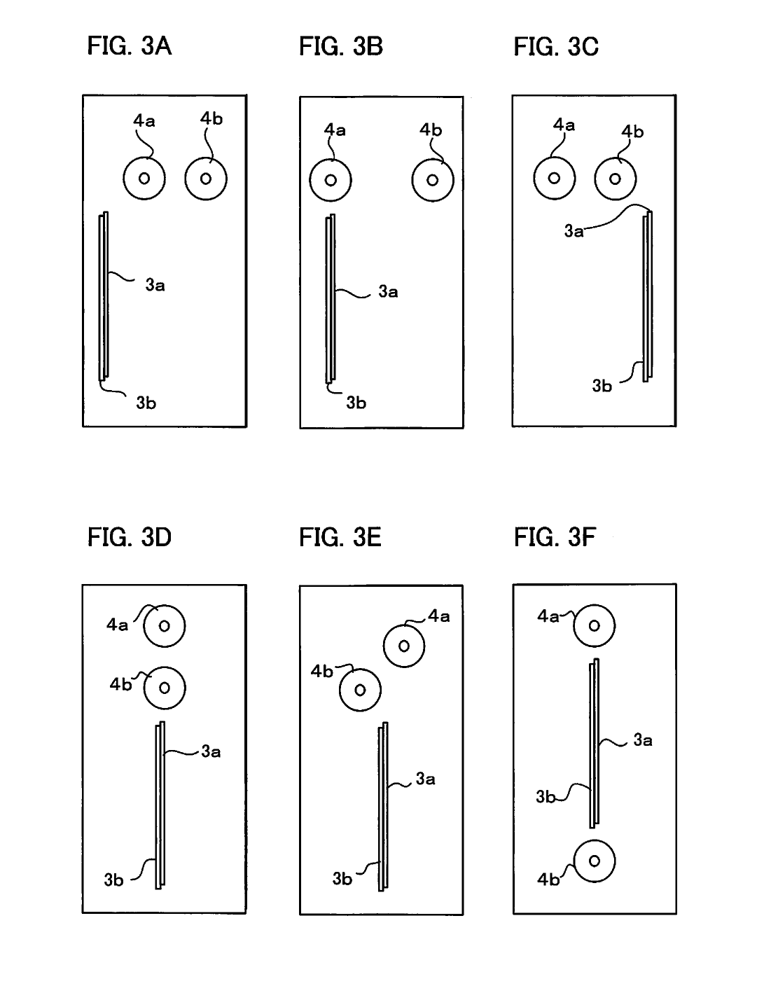

Further, a placement positional relationship of the ball screws 4a, 4b with the doors 3a, 3b has only such a limitation that an axial direction of the ball screws 4a, 4b is aligned with a sliding direction of the doors 3a, 3b, so that they can be placed fairly freely. FIGS. 3A to 3F are explanatory views each illustrating examples of placement positions of the ball screws 4a, 4b and the doors 3a, 3b. Further, the positions of the first ball screw 4a and the second ball screw 4b are replaceable.

FIG. 3A illustrates an example in which the first and second ball screws 4a, 4b are placed on an upper side and a rear side relative to the first and second doors 3a, 3b. Further, FIG. 3B illustrates an example in which the two ball screws 4a, 4b can be placed at any interval. FIG. 3C illustrates an example in which the ball screws 4a, 4b are placed on a front side relative to the doors 3a, 3b.

Further, in the examples of FIGS. 3A to 3C, an arrangement direction of the two ball screws 4a, 4b is along a vertical direction with respect of surfaces of the doors 3a, 3b. Meanwhile, FIG. 3D illustrates an example in which the arrangement direction of the two ball screws 4a, 4b is along a surface direction of the doors 3a, 3b. FIG. 3E illustrates an example in which the arrangement direction of the two ball screws 4a, 4b is placed at a given inclination with respect to the surface direction of the doors 3a, 3b. FIG. 3F illustrates an example in which the two ball screws 4a, 4b may be placed, respectively, on the upper side and on a lower side relative to the doors 3a, 3b. As such, a selection range of the positions to dispose the two ball screws and the power transmission mechanism is wide.

### Second Embodiment

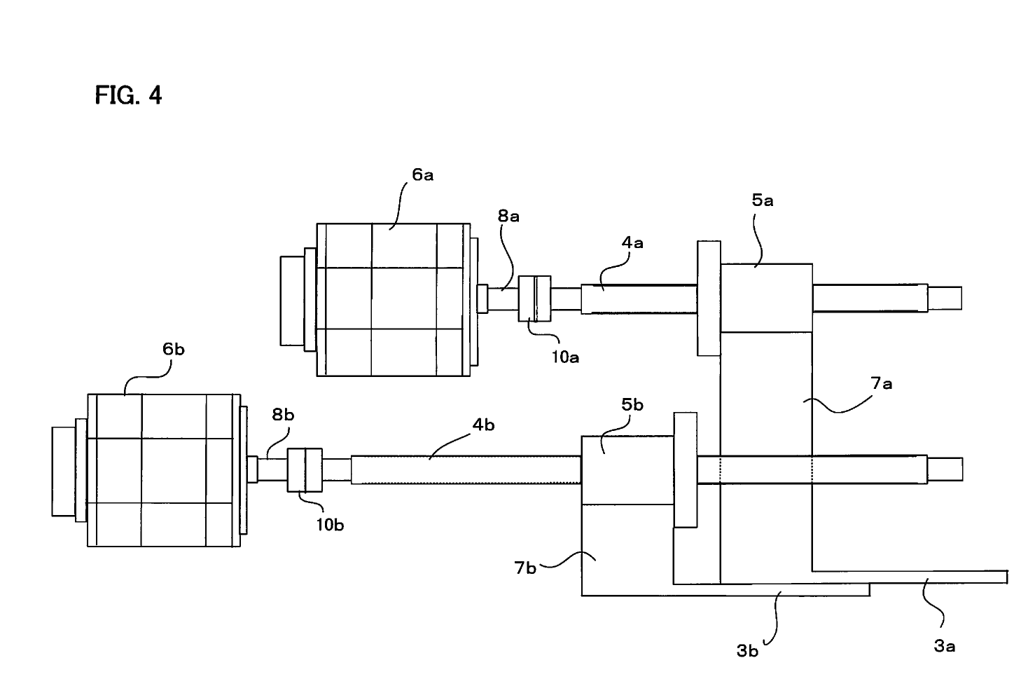

FIG. 4 is a schematic diagram of a second embodiment.

In the second embodiment, a driving motor is provided for each ball screw instead of providing the power transmission mechanism. The other configuration is the same as in the first embodiment.

A motor shaft 8a of a first motor 6a is connected to a first ball screw 4a via a shaft coupling 10a with their shaft centers being aligned. A motor shaft 8b of a second motor 6b is connected to a second ball screw 4b via a shaft coupling 10b with their shaft centers being aligned. Except that the power transmission mechanism 9 is not provided, the other configuration is the same as in the first embodiment, so a description thereof is omitted.

A first door 3a is driven by the first motor 6a via the first ball screw 4a and a nut 5a. A second door 3b is driven by the second motor 6b via the second ball screw 4b and a nut 5b. Since the doors 3a, 3b are driven by independent motors 6a, 6b, respectively, stroke amounts, moving speeds, moving start timings, and the like of the doors 3a, 3b can be obtained by control of the motors 6a, 6b. Because of this, the ball screws 4a, 4b may have different leads, but the leads may not necessarily be different. Even if the motors 6a, 6b are driven at the same time, rotation speeds of the motors 6a, 6b may be changed, so as to control a door with a short stroke to reach an end point of the stroke at the time when a door with a long stroke reaches an end point of the stroke. Further, even in a case where two motors 6a, 6b have the same speed, moving start timings may be shifted from each other, so as to control the motor 6a, 6b such that two doors 3a, 3b reach respective end points of respective strokes at the same time.

In the first and second embodiments described above, the opening is opened and closed by two doors, but the opening may be opened and closed by three doors. In this case, one set of a ball screw, a nut, and a door is further added to prepare three sets thereof in total, and the opening may be opened and closed by moving three doors by rotationally driving the ball screws by one motor and a power transmission mechanism, or by motors provided for respective ball screws.

### Third Embodiment

In the first and second embodiments described above, two doors are moved in the same direction so as to open and close the opening. However, in the third embodiment, two doors are moved in opposite directions so as to open and close an opening.

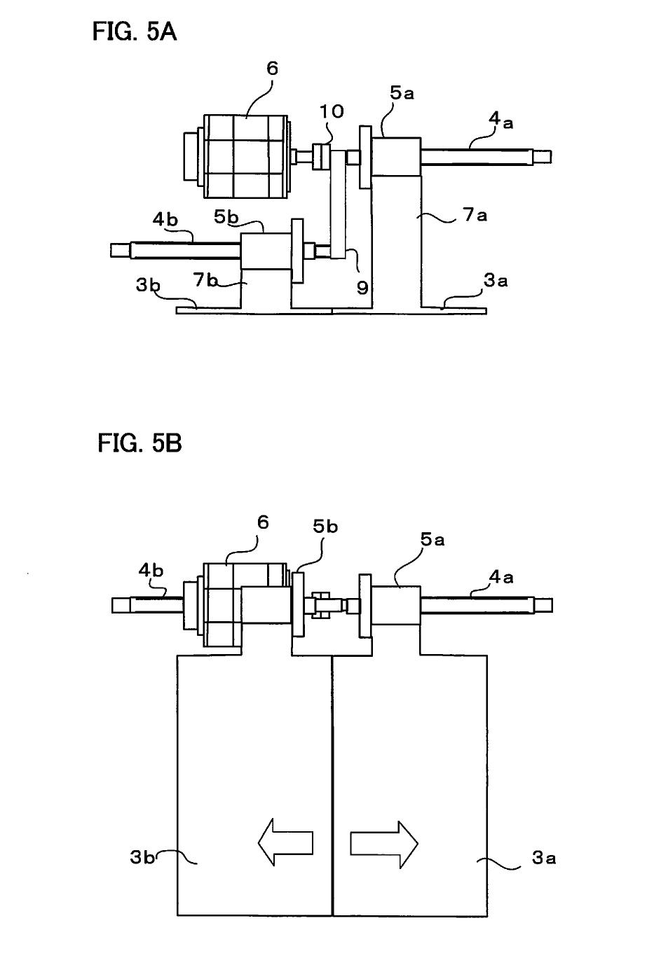

FIGS. 5A, 5B are schematic diagrams each illustrating a first aspect of the third embodiment: FIG. 5A is a plan view; and FIG. 5B is a front view. A first ball screw 4a is connected to a motor shaft of a motor 6 via a shaft coupling 10 with its shaft center being aligned with a shaft center of the motor. Further, the first ball screw 4a is connected to a second ball screw 4b via a power transmission mechanism 9. An extension member 7a of a first door 3a is fixed to a first nut 5a engaged threadedly to the first ball screw 4a. Further, an extension member 7b of a second door 3b is fixed to a second nut 5b engaged threadedly to the second ball screw 4b. FIGS. 5A, B illustrate a state where an opening is closed by two doors 3a, 3b. When the motor 6 is driven for a predetermined time in a door-open direction from this state, the first nut 5a and the first door 3a are moved in a right direction by a predetermined stroke and the second nut 5b and the second door 3b are moved in a left direction by a predetermined stroke, so as to open the opening. Further, when the motor 6 is driven for a predetermined time in a door-closing direction (in a direction opposite to the door-open direction), the nuts 5a, 5b and the doors 3a, 3b are moved in opposite directions by a predetermined stroke, so as to close the opening as illustrated in FIG. 5.

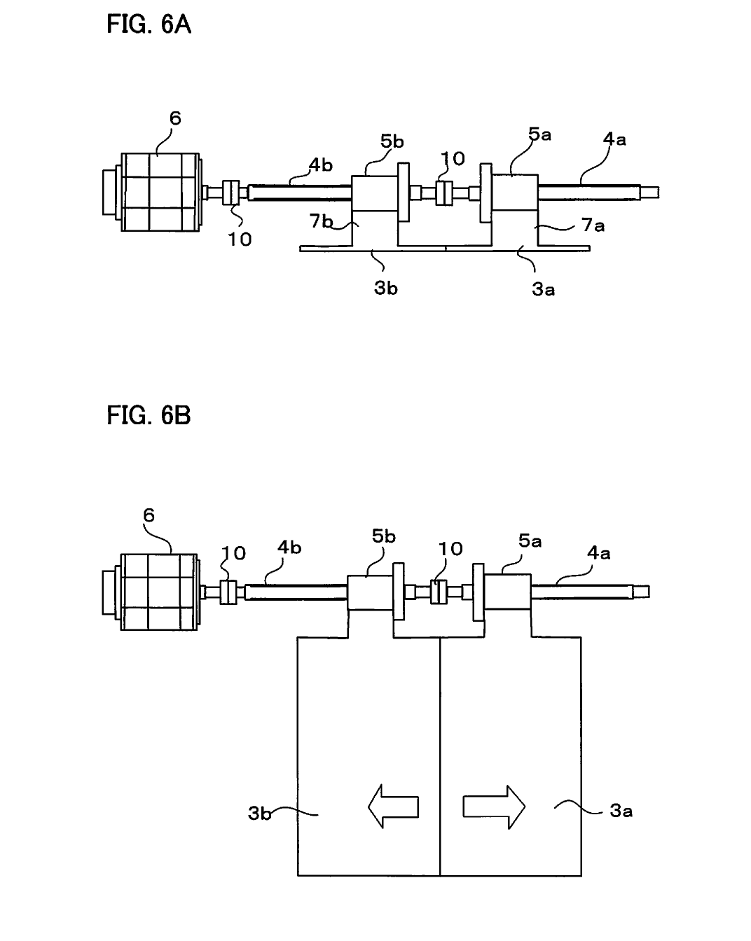

FIGS. 6A, 6B are schematic diagrams each illustrating a second aspect of the third embodiment: FIG. 6A is a plan view; and FIG. 6B is a front view. The second aspect uses a shaft coupling instead of a power transmission mechanism. A second ball screw 4b is connected to a motor shaft of a motor 6 via a shaft coupling 10 with its shaft center being aligned with a shaft center of the motor. A first ball screw 4a is connected to the other end of the second ball screw 4b via a shaft coupling 10 with their shaft centers being aligned. Second and first nuts 5b, 5a are engaged threadedly to the second and first ball screws 4b, 4a, respectively, and extension members 7a, 7b of the second and first doors 3b, 3a are fixed to the second and first nuts 5b, 5a, respectively.

The first ball screw 4a and the second ball screw 4b are threaded in opposite directions. Accordingly, when the motor 6 is rotated in one direction, the first and second nuts 5a, 5b are moved in opposite directions, so that the first and second doors 3a, 3b are also moved in opposite directions.

The states illustrated in FIGS. 6A, 6B are states where an opening is closed by the first and second doors 3a, 3b. When the motor 6 is driven for a predetermined time in a door-open direction from this state, the first nut 5a and the first door 3a are moved in a right direction by a predetermined stroke and the second nut 5b and the second door 3b are moved in a left direction by a predetermined stroke, so as to open the opening. Further, when the motor 6 is driven for a predetermined time in a door-closing direction (in a direction opposite to the door-open direction), the nuts 5a, 5b and the doors 3a, 3b are moved in opposite directions by a predetermined stroke, so as to close the opening as illustrated in FIGS. 6A, 6B.

In the first and second embodiments described above, when the opening is opened, two doors are accommodated so as to overlap with each other. However, in the third embodiment, it is necessary to provide door accommodation portions on both sides of the opening, thereby resulting in that an area of the accommodation portions is larger than the first and second embodiments, which is disadvantageous. However, the opening is closed by causing two doors to abut with each other, which makes it possible to increase a sealing degree as compared with a case where the opening is closed by causing the doors to overlap with each other.

Note that, even in the third embodiment, two doors may have different widths (widths in a slide direction). One of the doors may close half or more of the opening, and the other one of the doors may close a remaining small region of the opening. In this case, in the embodiment illustrated in FIGS. 6A, 6B, the first and second ball screws may have different leads, or even in a case where the ball screws have the same rotation amount, the nuts (the doors) may be set to have different moving amounts (strokes). Further, in the aspect illustrated in FIGS. 5A, 5B, the stroke amounts may be changed according to the widths of the doors by changing the speed reducing ratio of the power transmission mechanism 9. Alternatively, even in a case of a speed reduction ratio of “1”, the stroke amounts may be changed according to the widths of the doors by changing the leads of the ball screws 4a, 4b. Further, like the second embodiment, a motor may be provided for each ball screw.

Further, in the third embodiment, two doors are moved in opposite directions so as to open and close the opening. However, three or four doors may be provided so as to open and close the opening.

One of or both of the first door 3a and the second door 3b may be constituted by two doors. For example, in a case where the first door 3a is constituted by two doors, two doors are provided like the first embodiment instead of the first door 3a, and the two doors may be moved in the same direction with different strokes. In this case, the numbers of ball screws, nuts, and power transmission mechanisms are increased.

1. A slide door of a machine tool, the slide door being constituted by first and second doors for opening and closing, in a sliding manner, an opening provided in a fixed cover for covering a machining space of the machine tool, the slide door being characterized by comprising:
a first nut fixed to the first door;
a first ball screw engaged threadedly to the first nut;
a second ball screw placed in parallel with the first ball screw;
a second nut engaged threadedly to the second ball screw and fixed to the second door; and
a motor for driving the first and second ball screws via a power transmission mechanism.

2. The slide door of the machine tool, according to claim 1, wherein:
either one of the first and second ball screws is connected to a motor shaft of the motor, instead of the power transmission mechanism, with their shaft centers being aligned; and
the one of the ball screws is connected to the other one of the ball screws via the power transmission mechanism.

3. The slide door of the machine tool, according to claim 1, wherein:
two motors are provided instead of the power transmission mechanism; and
the first ball screw is driven by one of the motors, and the second ball screw is driven by the other one of the motors.

4. The slide door of the machine tool, according to claim 1, wherein
the power transmission mechanism includes a speed change mechanism for rotating the first ball screw and the second ball screw at a predetermined rotational speed ratio.

5. The slide door of the machine, according to claim 1, wherein the first ball screw and the second ball screw are configured to have different leads.

6. The slide door of the machine tool, according to claim 1, wherein:
the first door and the second door are moved in the same direction;
the second door is moved by a stroke longer than a stroke of the first door; and
at the time when the opening is opened fully, the first door and the second door are placed at an accommodation position so as to overlap with each other.

7. The slide door of the machine tool, according to claim 1, wherein
the first door and the second door are moved in opposite directions to each other so as to open and close the opening.

8. The slide door of the machine tool, according to claim 1, wherein:
instead of placing the power transmission mechanism and the first and second ball screws in parallel with each other, a motor shaft of the motor, the first ball screw, and the second ball screw are connected in series so as to be fixed to each other with their shaft centers being aligned; and
the first ball screw and the second ball screw are configured to have different leads.

9. The slide door of the machine tool, according to claim 1, wherein:
instead of placing the power transmission mechanism and the first and second ball screws in parallel with each other, a motor shaft of the motor, the first ball screw, and the second ball screw are connected in series so as to be fixed to each other with their shaft centers being aligned; and
threading directions of the first ball screw and the second ball screw are opposite to each other.
